(19) United States
(12) Patent Application Publication
(10) Pub. No.: US 2011/0235520 A1
(43) Pub. Date: Sep. 29, 2011

(54) LIVE MONITORING OF CALL SESSIONS OVER AN IP TELEPHONY NETWORK

(75) Inventors: Mike Maciej, Rogers, MN (US); James Paul Martin, II, Vandais Heights, MN (US); Mike Bendickson, Ramsey, MN (US)

(73) Assignee: Calabrio, Inc., Minneapolis, MN (US)

(21) Appl. No.: 12/732,928

(22) Filed: Mar. 26, 2010

(51) Int. Cl. H04L 12/26

(52) U.S. Cl. 370/241

(57) ABSTRACT

Systems and methods for monitoring call sessions over an IP telephony network are disclosed. An illustrative system for monitoring call sessions over an IP telephony network includes a number of user telephone stations, a communications manager configured to direct call session data streams to the user telephone stations, and an application configured to receive the call session data streams and direct those streams to one or more monitoring stations for monitoring. The call session data streams can be sent directly to the monitoring stations or can be sent to the monitoring stations via a monitoring server that forwards the call session data streams to a record service or record server.

### TECHNICAL FIELD

The present invention relates generally to the field of monitoring voice and data communications over a network. More specifically, the present invention pertains to systems and methods for live monitoring of call sessions conducted over an IP telephony network.

### BACKGROUND

Live monitoring of call sessions conducted over an IP telephony network is becoming increasingly important in certain industries for monitoring the quality of customer interactions that occur during a telephone call. In the financial services industry, for example, the monitoring of telephone calls is often necessary to ensure legal and regulatory compliance with securities laws and regulations, and to evaluate customer interactions for quality assurance and training purposes. In some cases, for example, a telephone conversation between a customer and a financial services representative may need to be monitored by a supervisor or compliance officer to determine whether the representative has asked the customer certain questions relating to the suitability of a particular trade or order, or to ascertain the representative's performance in response to a particular type of call. Other industries in which telephone call sessions are routinely monitored include customer service centers for monitoring a representative's performance in settling customer complaints and/or for training purposes.

The monitoring of call sessions over a Voice over Internet Protocol (VoIP) network is typically accomplished using a communications manager such as the Cisco Unified Communications Manager (CUCM) from Cisco Systems, Inc. of San Jose, Calif. or the Avaya Aura™ Communications Manager from Avaya, Inc. of Basking, N.J., which are responsible for routing calls to designated user telephone stations linked to the network. In some cases, for example, the communications manager can be tasked to communicate with a router or gateway using a protocol such as Media Gateway Control Protocol (MGCP), which negotiates the voice and data streams back and forth between the parties to a call session and the user's telephone station as end-points. To permit the monitoring of call sessions by an individual other than the individual assigned to handle the call, the communications manager can be tasked to direct voice data packets from the user's telephone station to another user's station for monitoring. The voice data then appears as a phone call on the other user's telephone station, which can be listened to.

In certain circumstances, it may be desirable for multiple individuals to monitor a particular call session. In the financial services industry, for example, it may be desirable for a supervisor to monitor the call session for quality assurance purposes and a compliance officer to simultaneously monitor the call session to ensure that legal and regulatory rules are met. In many monitoring systems, however, the communications manager tasked to direct voice data for the purpose of monitoring call sessions may only be capable of allowing one or a limited number of individuals to monitor the session at a time. Moreover, in those embodiments in which the individual's monitoring station is equipped with both a telephone and a computer desktop, the directing of voice data to that station may also create confusion as to where the call session will appear.

In certain circumstances, it may be desirable to provide a common or standard method of monitoring call sessions regardless of the telephony platform limitations or capabilities. In some cases, the communications manager may not be capable of directing voice traffic to an individual that desires to monitor a call session, making the monitoring of the call session more difficult.

In certain circumstances, it may also be desirable to provide a single monitoring destination that does not have a dependency on the logical or physical connectivity of the IP telephony system. In some circumstances, for example, a supervisor may want to monitor calls conducted over telephone stations that are logically or physically separated from the supervisor's monitoring station, or the supervisor may want to monitor calls conducted over multiple, logically or physically separate IP telephony systems. In some cases, it may also be desirable to provide a single monitoring destination that does not have a dependency on a single IP telephony system, and that can operate with different types of IP telephony systems.

### SUMMARY

The present invention pertains to systems and methods for live monitoring call sessions conducted over an IP telephony network. An illustrative system for monitoring call sessions includes one or more user telephone stations, a communications manager configured to direct call sessions to the user telephone stations, a means for receiving call session data streams from multiple call sessions and directing those streams to one or more destinations, and one or more monitoring stations configured for monitoring the call sessions. In some embodiments, the call session data streams can comprise voice and/or application data streams that can be fed to one or more record services or record servers, either directly from a user's telephone station, via a router or gateway, and/or via a monitoring server in communication with a record service or record server and the router or gateway. The record services or record servers, in turn, can then forward the call session data streams to one or more monitoring stations for monitoring.

An illustrative method of monitoring call sessions over an IP telephony network includes receiving a call request to initiate a call session between two or more parties, assigning the call request to a user telephone station, prompting a communications manager to direct call session data streams from the call session to an application configured for receiving the streams, and directing the call session data streams to one or more destinations for monitoring. In some embodiments, the call session data streams can comprise multiple call session data streams using a suitable protocol such as Real-Time Transport Protocol (RTP). In other embodiments, the call session data stream can comprise a combined call session data stream.

An illustrative method of monitoring call sessions over multiple logically or physically separate IP telephony systems includes receiving a call request to initiate a call session between two or more parties, assigning the call request to a user telephone station, prompting the communications manager to direct call session data streams to an application configured for receiving the streams, and prompting the application make that call session data streams available to one or more destinations for monitoring.

An illustrative method of monitoring a call session over multiple different types of IP telephony systems includes receiving a call request to initiate a call session between two or more parties, assigning the call request to a user telephone station, prompting the communications manager to direct call session data streams to an application configured for receiving the streams, and prompting the application to make the call session data streams available to one or more destinations for monitoring.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a schematic view of an illustrative system for live monitoring call sessions over an IP telephony network;

FIG. 2 is a schematic view of another illustrative system for live monitoring call sessions over an IP telephony network including a monitoring server;

FIG. 3 is a flow diagram showing an illustrative method of live monitoring a call session using the illustrative system of FIG. 1;

FIG. 4 is a schematic view showing an illustrative implementation of the method of FIG. 3 using the illustrative system of FIG. 1;

FIGS. 5A-5B is a flow diagram showing an illustrative method of live monitoring a call session using the illustrative system of FIG. 2; and

FIG. 6 is a schematic view showing an illustrative implementation of the method of FIGS. 5A-5B using the illustrative system of FIG. 2.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

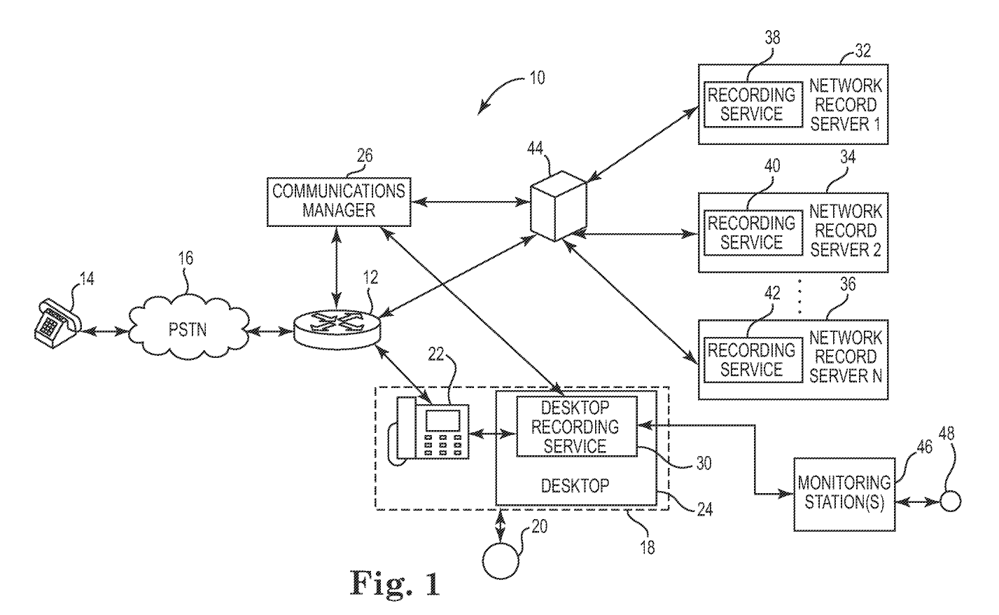

FIG. 1 is a schematic view of an illustrative system 10 for live monitoring of call sessions over an IP telephony network. The system 10, illustratively an IP telephony system for monitoring telephone call sessions made over a Voice over Internet Protocol (VoIP) network, includes a router or gateway 12 that routes calls from a caller 14 via a Public Switched Telephone Network (PSTN) 16 to a user telephone station 18 for handling by an individual or multiple individuals 20. The telephone station 18 may comprise, for example, a VoIP-enabled telephone 22 and computer desktop 24 that can be used by an individual 20 to communicate with, and in some embodiments also record, inbound or outbound call sessions with callers 14. In a customer service center environment, for example, the telephone station 18 can comprise a VoIP-enabled telephone 22 and the computer desktop 24 can comprise a desktop or laptop computer that can be used to access information about a caller's 14 account. In certain embodiments, the VoIP telephone 22 can be implemented as a soft phone executing on a computer. In other embodiments, the VoIP telephone 22 can comprise a stand-alone telephone. In use, the equipment associated with each telephone station 18 may be used to carry out voice and data communications with callers 14. In some embodiments, the telephone station 18 may also include video conferencing equipment adapted to obtain video data, which can be recorded along with the voice data for later playback and/or analysis.

Although only a single telephone station 18 is shown in FIG. 1, multiple telephone stations 18 or extensions can be connected to the system 10 for handling call sessions from multiple callers 14. Moreover, although an example telephone station 18 is shown having a particular desktop configuration, the telephone station 18 can have other configurations that include a greater or lesser number of components than that shown. In one embodiment, for example, the telephone station 18 can comprise a soft phone that operates on the computer desktop 24. In another embodiment, the computer desktop 24 can comprise a separate device that is linked to the telephone 22 via either a wired or wireless connection.

A communications manager 26 is configured to send commands to the router or gateway 12 for routing callers 14 to each telephone station 18. For a VoIP network operating in conjunction with a PSTN network 16, for example, the communications manager 26 may comprise a system such as the Cisco Unified Communications Manager (CUCM) or the like, which can communicate with the router or gateway 12 using a suitable protocol such as a Media Gateway Control Protocol (MGCP), which negotiates the voice data streams back and forth between the caller 14 and the telephone station 18. In those embodiments in which audio-visual communications are to occur between the caller 14 and telephone station 18, a suitable multimedia protocol such as H323 or the like may be used by the communications manager 26 to signal and control multimedia content between the caller 14 and the telephone station 18.

In certain embodiments, the telephone 22 can comprise a VoIP telephone having a built-in-bridge (BIB) feature that enables transmission of voice and/or video streams from the telephone 22 to another service, allowing an individual 20,48 to initiate the recording and/or monitoring of a call session with a caller 14 directly from the user's telephone 22. In some embodiments, for example, an individual 20 may initiate a call session to be recorded by selecting a button or inputting a command on the telephone 22. Alternatively, or in addition, the communications manager 26 may automatically initiate the recording and/or monitoring of a call session with a caller 14 based on a business rule or condition from a third-party application (e.g., an enterprise software application), or from a manual request made by another individual 20,48 from another telephone station 18 and/or desktop 24.

In the embodiment of FIG. 1, the desktop 24 functions as a desktop recording service for recording call sessions with callers 14. As used herein, the term desktop can be comprised of any software and/or hardware that can be used by one or more individuals 20 in conjunction with the handling of an inbound or outbound call session with a caller 14. In some embodiments, the desktop 24 can be a logical location on a network such that communications ongoing in relation to the logical location can be targeted and/or a physical location such that communications associated with the individual 20 are targeted. To enable recording of call sessions, the desktop 24 can be associated with a desktop recording service 30, which can be configured to run on the desktop 24 or on another device in communication with the desktop 24. In some embodiments, for example, the desktop recording service 30 can comprise a software program and/or hardware that operates over the desktop 24. In other embodiments, the desktop recording service 30 can comprise a software program and/or hardware that operates on a separate (e.g., remote) device that communicates with the desktop 24. Other configurations are also possible.

The desktop recording service 30 can include one or more permanent and/or temporary storage services for storing voice data, and in some embodiments also video, screen capture, and/or additional call session data captured by the telephone station 18. The desktop recording service 30 may include, for example, one or more magnetic or optical storage services for storing voice data as well as other call data associated with recorded call sessions. An example of call data that can be associated with each recorded call session can include service data point (SDP) information from a user's telephone station 18 such as caller ID, directory number (DL), service name (e.g., MAC address), line display name, near-end/far-end data, etc. Other information such as time/date stamp information and metadata can also be associated with each recorded call session. The desktop 24 and/or desktop recording service 30 can also include various other functionality, including, but not limited to, enterprise business applications, instant messaging, browsing, chat, message boards, and/or email capabilities.

In some embodiments, the desktop recording service 30 is configured to facilitate the routing and recording of call sessions, either as a primary recording service or as a secondary or backup service. The desktop recording service 30 can comprise, for example, a software program operable on the computer desktop 24 for establishing and managing communications between the router or gateway 12, the telephone 22, the communications manager 26, as well as one or more network record servers 32,34,36. As discussed further herein, the desktop recording service 30 can also be configured to forward voice as well as other call session data streams to one or more monitoring stations 46 for live monitoring by a third party 48, either directly from the user telephone station 18 tasked to handle the call session, or alternatively, by forwarding the call session data streams to a network record server 32,34,36 or other record service or record server. In certain embodiments, the desktop recording service 30 can be configured to route multiple call session data streams of a single call session to several monitoring stations 46, allowing multiple individuals 48 to simultaneously monitor the call session in real-time. Each of the monitoring stations 46 can be equipped with a telephone, speaker, display screen, and/or other suitable means for monitoring the call session.

To enable recording at the desktop level, the desktop recording service 30 can be configured to receive both incoming and outbound voice data from the user's telephone 22, which can then be sent to the desktop recording service 30 for preservation. In some embodiments, the voice data component of the call session streams can be in the form of RTP data streams or the like. The configuration of the desktop recording service 30 can be accomplished, for example, by running a setup routine on the desktop 24 to enable the desktop recording service 30 to record call sessions, or by querying the communications manager 26 to determine if the telephone 22 connected to the desktop 24 includes a built-in-bridge feature capable of receiving voice data (e.g., RTP voice data) from the telephone 22. If the telephone 22 is already configured for recording, the desktop recording service 30 may still connect to a computer telephony integration (CTI) service, but would only record a call session when directed by the communications manager 26 via a signaling mechanism such as a Session Initiated Protocol (SIP) message to record the call session. In some embodiments, the desktop recording service 30 records the call session even though it was not directed by the communications manager 26. In this instance, desktop recording service 30 is recording the call session as a secondary or backup method of preserving the recording in case a failure occurs with the primary recording service. In some embodiments, the desktop recording service 30 can also be configured to record video and/or screen data associated with the desktop 24 when a request to record voice data is initiated by the communications manager 26.

The system 10 further includes one or more additional record servers 32,34,36 each configured to operate over a network such as a WAN, LAN, or VLAN for recording call sessions between the user telephone station 18 and callers 14. In some embodiments, for example, the network record servers 32,34,36 can be tasked to record audio and/or video packets in the event of a failure or overflow error in the desktop recording service 30, an interruption in the communication between the telephone 22 and the desktop 24, and/or in the event the user's telephone station 18 is not equipped with its own desktop recording service 30. As an example, the network record servers 32,34,36 can be tasked to record call sessions in those instances where there is no computer desktop 24 associated with an individual's telephone 22, or where for security reasons it is not desired to record the call session on the desktop recording service 30.

Each of the network record servers 32,34,36 can be associated with a network recording service 38,40,42 that establishes and manages data communications across the network. The network recording services 38,40,42 may comprise, for example, software programs operable on the network record servers 32,34,36 or another service connected to the network record servers 32,34,36. Although each network record server 32,34,36 can include a corresponding network recording service 38,40,42, in other embodiments a single network recording service can be configured to control multiple network record servers 32,34,36. In use, the network recording services 38,40,42 allow one or more of the network record servers 32,34,36 to subscribe to a particular call session to determine if the call session has ended, or alternatively determine whether the call has been placed on hold and is expected to continue. This allows the network recording services 38,40,42 to later determine how to handle file management associated with recorded call sessions.

A CTI/SIP proxy service 44 is configured to monitor the health or status of each of the desktop recording services 30 and the network record servers 32,34,36. The CTI/SIP proxy service 44 is an intermediate entity or interface that facilitates communications between the communications manager 26, the desktop recording services 30, and the network record servers 32,34,36. The CTI/SIP proxy server 44 may comprise, for example, a software application and/or hardware that directs RTP streams from each user telephone station 18 to the corresponding desktop recording service 30 and/or to the network record servers 32,34,36, and which manages CTI/SIP sessions between the desktop recording services 30, the communications manager 26, and the network record servers 32,34,36. As an example, the CTI/SIP proxy service 44 may determine which network record server 32,34,36 and/or desktop recording service 30 should record a particular call session based on configuration information stored in a file or database.

In some embodiments, the desktop recording service 30 comprises the primary service for recording call sessions over the system 10. To reduce network bandwidth usage across various network components, for example, the system 10 can be configured to route call sessions to the desktop recording service 30 for recording. During a call session, the desktop recording service 30 can be configured to sniff RTP streams received and transmitted back and forth between the telephone 22 and caller 14, allowing the desktop recording service 30 to record the call session without placing any additional load on the network. This may also be useful if the telephone 22 does not have the ability to route packets directly such as that performed, for example, by a telephone having a built-in-bridge (BIB) feature. Recording call sessions in this manner helps to reduce network traffic, thus increasing the bandwidth available for other services to operate over the network. Call sessions previously recorded on the desktop recording services 30 can then be transmitted to the network record servers 32,34,36 at a later time when system demand is relatively low such as during non-business or overnight hours.

The network record servers 32,34,36 can also be tasked to record call sessions in tandem with the desktop recording services 30 to ensure the uninterrupted recording of call sessions in the event of an infrastructure failure in one of the desktop recording services 30. The call session recorded on the desktop recording service 30 can then be deleted upon confirmation that the network record server 32,34,36 successfully recorded the call session, thus eliminating the need to upload or preserve the recording. The file management of recorded call sessions can also be managed in accordance with configuration information provided by the communications manager 26, the desktop recording service 30, the CTI/SIP proxy service 44, the network recording services 38,40,42, and/or one or more other system components.

The desktop recording service 30 can be configured to receive call session data including both a telephone user voice data stream and a caller voice data stream in order to record both incoming and outgoing voice data. To enable multiple individuals 48 to simultaneously monitor the call session in real-time, the desktop recording service 30 can also be configured to split the call session data streams and feed each stream to multiple destinations for monitoring. By way of example and not limitation, the desktop recording service 30 can be configured to split the call session data into two sets of call session data streams each containing a telephone user voice data stream and a caller voice data stream, and then deliver the two sets of call session data streams to two monitoring stations 46 for live monitoring. To enable delivery of call session data streams to one or more monitoring stations 46, the communications manager 26 can be configured to transmit start and stop SIP messages to the desktop recording service 30, prompting the service 30 to start/stop delivering the call session data streams to a designated monitoring station 46. To facilitate routing, the start and stop messages can contain the IP address and port numbers of the monitoring station 46 designated to receive the call session data streams.

In some embodiments, the desktop recording service 30 can also be configured to operate on the computer desktop 24 or another device coupled to the desktop 24 as a recording service for recording call session data during a call session. In such case, the call session packets received from the user's telephone 22 can be split into one set of call session data streams for recording by the desktop recording service 30 and additional sets of call session data streams for forwarding to those monitoring stations 46 designated for monitoring the call session. Several examples of configuring and operating a computer desktop as a desktop recording service are further disclosed, for example, in co-pending U.S. patent application Ser. No. 12/716,810, entitled “Desktop Recording Architecture For Recording Call Sessions Over A Telephony Network,” which is incorporated herein by reference in its entirety for all purposes.

Because the call session data streams are delivered directly from the computer desktop 24 to the monitoring station 46 instead of relying on the communications manager 26 to provide such functionality, the system 10 may permit any number of individuals 48 to monitor call sessions simultaneously. Moreover, because the delivery of call session data streams occurs at the desktop level from the user's computer desktop 24, the system 10 reduces the amount of traffic sent across the network.

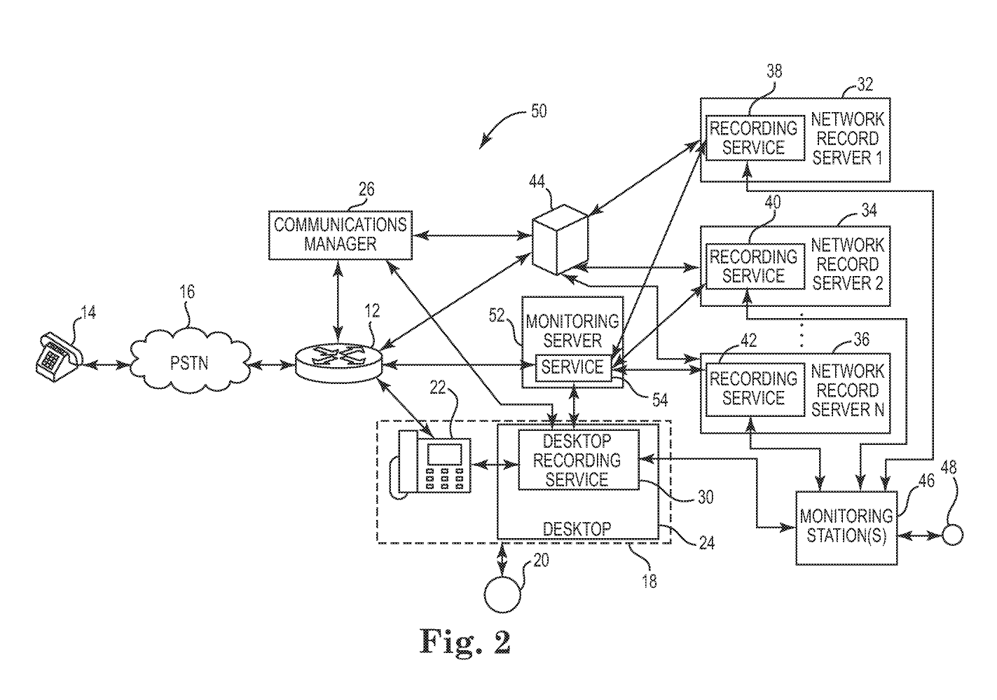

FIG. 2 is a schematic view of another illustrative system 50 for live monitoring of call sessions over an IP telephony network. The system 50 is similar to system 10 described above with respect to FIG. 1, in which like elements are labeled in like manner in the figures. In the embodiment of FIG. 2, however, the system 50 further includes a monitoring server 52 that be tasked to duplicate and route call sessions conducted via the user telephone stations 18 to one or more of the network record servers 32,34,36. The monitoring server 52 includes a monitoring service 54 that is used to establish and manage data communications with the router or gateway 12 and with the network record servers 32,34,36. The monitoring service 54 may comprise, for example, a software program and/or hardware operable on the monitoring server 52 or another device connected to the server 52. In use, and as discussed further herein, the monitoring service 54 can be configured to receive inbound and outbound call session data streams from a call session conducted by a user telephone station 18, and then forward those call session data streams to an associated network record server 32,34,36, which, in turn, forwards the call session data streams to one or more monitoring stations 46 for monitoring by a third party 48.

In the embodiment of FIG. 2, one or more of the network recording services 38,40,42 can be configured to receive call session data containing both a telephone user voice data stream and a caller voice data stream, either directly from a network component such as a router or gateway 12, phone 22, or via the monitoring server 52. To enable multiple individuals 48 to monitor the call session, the network recording service 38,40,42 can be configured to forward the call session data streams to one or more of the monitoring stations 46. To enable forwarding of the call session data streams, the communications manager 26 can be configured to transmit start and stop SIP messages to each network recording service 38,40,42, prompting the services 38,40,42 to start/stop forwarding the call session data streams to a designated monitoring station 46. To facilitate routing, the start and stop messages can contain the IP address and port number of the monitoring station 46 to receive the call session data.

In some embodiments, the forwarding of call session data streams to the monitoring stations 46 can be performed both at the desktop level via the desktop recording service 30 and via one or more of the network record servers 32,34,36. If, for example, a first user telephone station 18 is equipped with a desktop recording service 30 and a second user telephone station 18 is not equipped with a desktop recording service, the system may forward the call session data streams from the first user telephone station 18 to a monitoring station 46 directly from the user's desktop 24 whereas the call session data streams from the second user telephone station 18 can be sent to a monitoring station 46 via another application such as one of the network record servers 32,34,36.

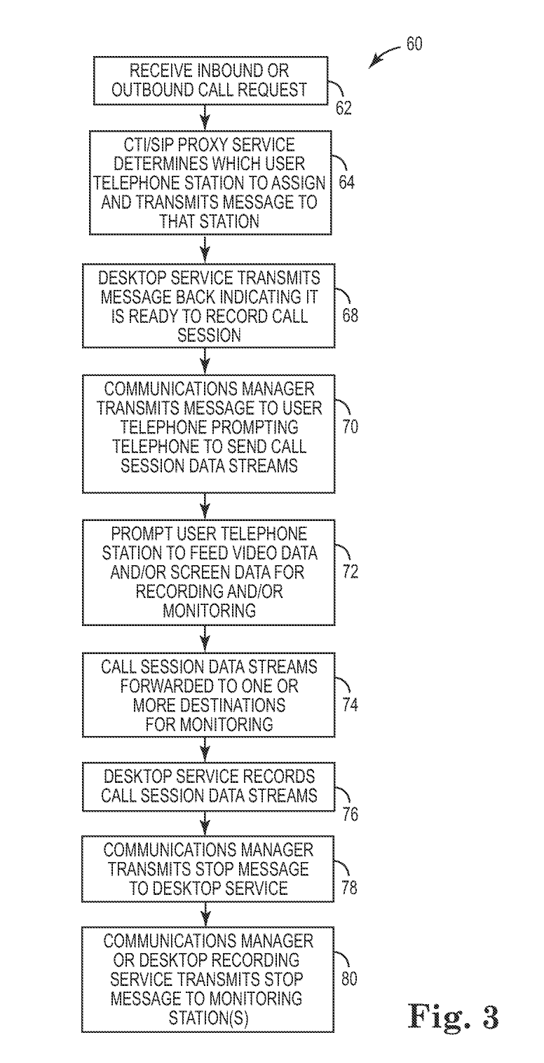

FIG. 3 is a flow diagram showing an illustrative method 60 of live monitoring a call session using the illustrative system 10 of FIG. 1. As shown in FIG. 3, the method 60 may begin generally at block 62, in which an inbound or outbound call request is received. When a call request is received, the CTI/SIP proxy service 44 determines which user telephone station 18 to assign for handling the recording and/or monitoring session, and transmits a SIP message to that station 18 (block 64). In those embodiments in which the desktop recording service 30 is also tasked as a recording service for recording the call session, the SIP message may also indicate that it is ready for recording (block 68).

Once the communications manager 26 receives a message indicating that the computer desktop 24 is ready, the communications manager 26 may then send a message to the user's telephone 22 prompting the telephone 22 to send call session data streams to the desktop recording service 30 (block 70). The call session data streams can include both a telephone user voice data stream and a caller voice data stream in order to permit the recording and/or monitoring of both incoming and outgoing voice data. In those embodiments in which the user telephone station 18 further includes videoconferencing and/or screen capturing capabilities, a message from the desktop recording service 30 may also prompt the user telephone station 18 to feed video data and/or screen data for recording and/or monitoring along with the voice data (block 72).

The call session data streams received by the desktop recording service 30 can then be forwarded directly to one or more monitoring stations 46, allowing any number of third parties 48 to monitor the call session in real-time (block 74). In those embodiments in which the desktop recording service 30 is also configured to function as a recording service, the desktop recording service 30 can also begin to record the call session data streams via the computer desktop 24 or another device coupled to the desktop 24 (block 76). At the conclusion of the call session, the communications manager 26 transmits a stop message to the desktop recording service 30 indicating that the call session data streams have stopped (block 78). A similar message can be transmitted from the communications manager 26 or desktop recording service 30 to those monitoring stations 46 used to monitor the call session (block 80).

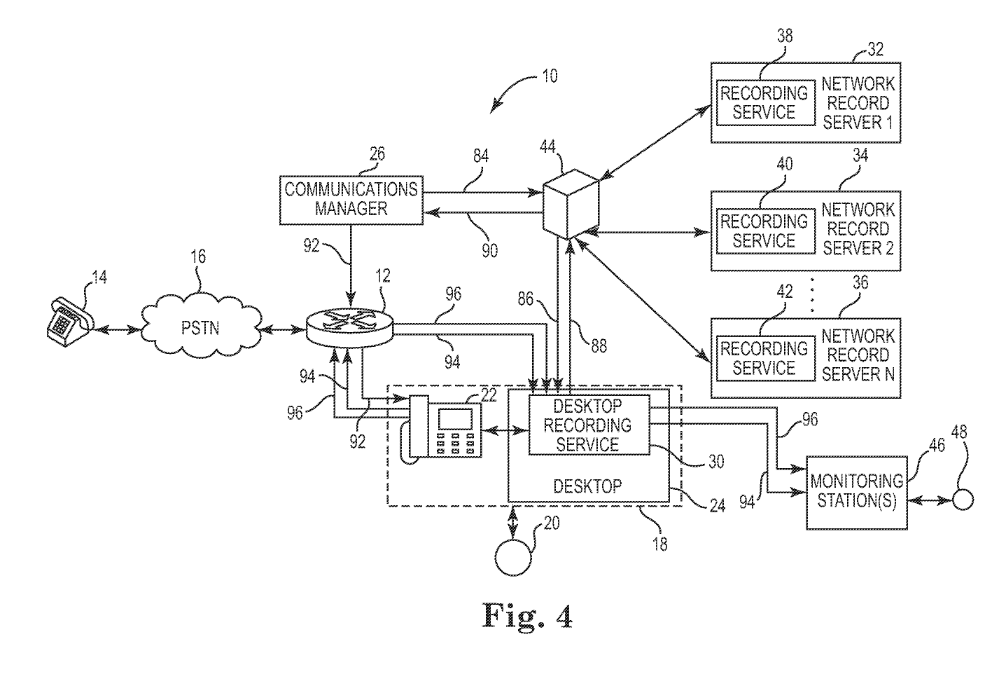

FIG. 4 is a schematic view showing an illustrative implementation of the method 60 of FIG. 3 using the illustrative system 10 of FIG. 1. As shown in FIG. 4, when an inbound or outbound call request is received, the communications manager 26 sends a message 84 to the CTI/SIP proxy service 44, which determines which user telephone station 18 to assign to handle the recording and/or monitoring session. The CTI/SIP proxy service 44 then transmits a SIP message 86 to that station 18 inviting the station 18 to the recording and/or monitoring session. The desktop recording service 30 associated with the assigned user telephone station 18 then transmits a SIP message 88 back indicating that it is ready to receive the recording and/or monitoring session.

Once the communications manager 26 receives a message 90 from the CTI/SIP proxy service 44 indicating that the user telephone station 18 is ready, the communications manager 26 may then send a SIP message 92 to the user's telephone 22, prompting the telephone 22 to send a telephone user 20 voice data stream 94 and a caller 14 voice data stream 96 to the computer desktop 24. If the call session is to be recorded by another record service or record server (e.g., network record server 36), the voice data streams 94,96 can also be transmitted to that record server for recording.

The voice data streams 94,96 are then forwarded to each monitoring station 46 that requests to monitor the call session. Live monitoring can be initiated, for example, in response to a third party 48 making a request to the communications manager 26 to monitor a particular call session. Alternatively, or in addition, the forwarding of the call session data streams 94,96 to a monitoring station 46 can occur automatically in response to an event, or based on a request made by the user 20 or another third party.

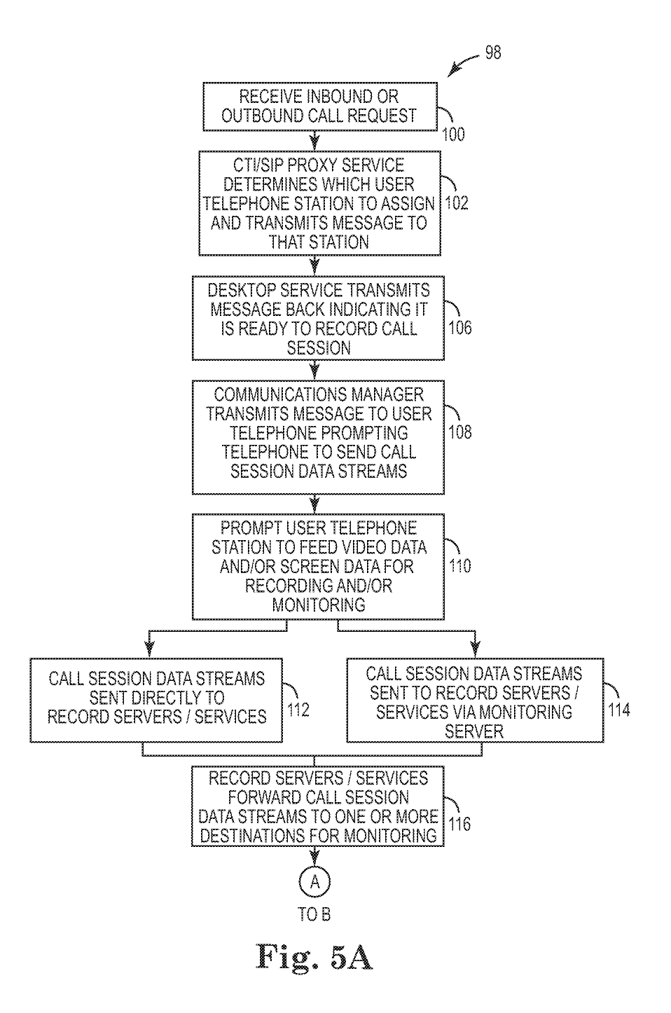

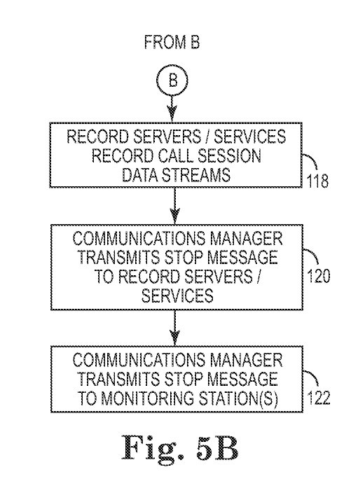

FIGS. 5A-5B is a flow diagram showing an illustrative method 98 of monitoring a call session using the illustrative system 50 of FIG. 2. As shown in FIGS. 5A-5B, the method 98 may begin generally at block 100, in which an inbound or outbound call request is received. When a call request is received, the CTI/SIP proxy service 44 may then determine which user telephone station 18 to assign for handling the recording and/or monitoring session, and transmits a SIP message to that station 18 (block 102). In those embodiments in which the desktop recording service 30 is also tasked as a recording service for recording call sessions, the SIP message may also indicate that it is ready for recording (block 106).

The communications manager 26 may then send a SIP message to the user's telephone 22 prompting the telephone 22 to send call session data streams to the desktop recording service 30 (block 108). The call session data streams can include both a telephone user voice data stream and a caller voice data stream in order to permit the recording and/or monitoring of both incoming and outgoing voice data. In those embodiments in which the user telephone station 18 further includes videoconferencing and/or screen capturing capabilities, the SIP response from the desktop recording service 30 may also prompt the user telephone station 18 to feed video data and/or screen data for recording and/or monitoring along with the voice data (block 110).

In the embodiment of FIGS. 5A-5B, the call session data streams from the user telephone 22 are also sent via the router or gateway 12 to a designated network record service 38,40,42, either directly from the router or gateway 12 (block 112), or alternatively, via the monitoring server 52 (block 114). The network record server 32,34,36 can then forward the call session data streams to the monitoring station 46 (block 116). If configured, one or more of the network record servers 32,34,36 can also record the call session data streams (block 118). At the conclusion of the call session, the communications manager 26 transmits a stop message to the network record service 38,40,42 indicating that the call session data streams have stopped (block 120). A similar message can be transmitted from the communications manager 26 to those monitoring stations 46 used to monitor the call session (122).

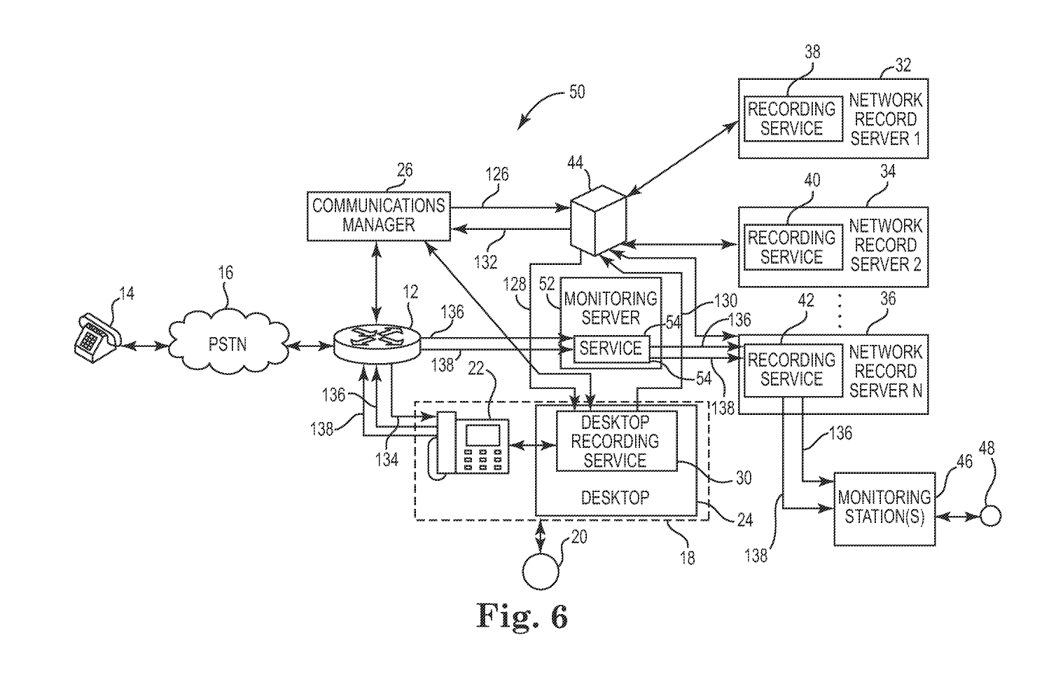

FIG. 6 is a schematic view showing an illustrative implementation of the method 98 of FIG. 5 using the illustrative system 50 of FIG. 2. As shown in FIG. 6, when an inbound or outbound call request is received, the communications manager 26 sends a request 126 to the CTI/SIP proxy service 44, which determines which user telephone station 18 to assign to handle to call session. The CTI/SIP proxy service 44 then transmits a message 128 to that station 18 inviting the station 18 to the recording and/or monitoring session. The computer desktop 24 associated with the assigned user telephone station 18 then transmits a SIP message 130 back indicating that it is ready to receive the recording and/or monitoring session.

Once the communications manager 26 receives a message 132 from the CTI/SIP proxy service 44 indicating that the user telephone station 18 is ready, the communications manager 26 may then send a message 134 to the user's telephone 22, prompting the telephone 22 to send a telephone user 20 voice data stream 136 and a caller 14 voice data stream 138 to a designated network record server (e.g., network record server 36). If the call session is also to be recorded by another record service or record server such as the desktop recording service 30, the voice data streams 136,138 can also be transmitted to that service 30 for recording.

In some embodiments, the voice data streams 136,138 are fed over the network directly to the designated network server 36. Alternatively, and as shown in FIG. 6, the voice data streams 136,138 may be fed to the monitoring server 52, which then feeds the voice data streams 136,138 to be recorded to the designated network server 36 (e.g., via a switched port analyzer (SPAN) connection). The voice data streams 136,138 received by the network record server 36 are then forwarded to each monitoring station 46 that requests to monitor the call session.

Embodiments of the present invention may be provided as a computer program product, which may include a machine-readable medium having stored thereon instructions that may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A system for monitoring call sessions over an IP telephony network, the system comprising:
one or more telephone stations, at least one telephone station including a telephone and computer desktop;
a communications manager configured to direct call sessions to the one or more telephone stations;
a means for receiving call session data streams from multiple call sessions and directing those call session data streams to one or more destinations; and
one or more monitoring stations configured for monitoring call sessions; and
wherein an application is configured to forward call session data streams received from the telephone to the one or more monitoring stations.

2. The system of claim 1, wherein said means for receiving call session data streams from multiple call sessions and directing those call session data streams to one or more destinations includes a router or gateway coupled to the user telephone station.

3. The system of claim 1, wherein the application comprises a desktop recording service.

4. The system of claim 1, wherein the application comprises a router or gateway.

5. The system of claim 1, wherein the call session data streams includes a telephone user voice data stream and a caller voice data stream.

6. The system of claim 1, wherein the computer desktop further includes a desktop recording service, and wherein the desktop recording service is configured to record the call session data streams.

7. The system of claim 1, further including one or more network record servers each associated with a network recording service configured for recording call sessions.

8. The system of claim 7, wherein the application is configured to forward the call session data streams to the one or more network record servers.

9. The system of claim 1, wherein the application comprises a monitoring server.

10. The system of claim 9, wherein the call session data streams from the telephone are forwarded to one or more record services or record servers via the monitoring server.

11. The system of claim 1, wherein the one or more monitoring stations includes a plurality of monitoring stations each configured to simultaneously monitor a call session.

12. A method of monitoring a call session over an IP telephony network, the method comprising:
receiving a request to initiate a call session between two or more parties;
assigning the call request to a user telephone station including a telephone and a computer desktop;
prompting a communications manager to direct call session data from the call session to an application configured for receiving the call session data; and
directing the call session data to one or more destinations for monitoring.

13. The method of claim 12, wherein the call session data includes a telephone user voice data stream and a caller voice data stream.

14. The method of claim 13, wherein the computer desktop further includes a desktop recording service configured to record the telephone user voice data stream and the caller voice data stream.

15. The method of claim 14, further including one or more additional record services or record services configured to record the telephone user voice data stream and the caller voice data stream.

16. The method of claim 12, wherein the call session data includes multiple call session data streams.

17. The method of claim 12, wherein directing the call session data includes directing the call session data from the telephone to one or more record services or record servers via a router or gateway.

18. The method of claim 12, further including a monitoring server, and wherein directing the call session data includes directing the call session data from the telephone to one or more record services or record servers via the monitoring server.

19. The method of claim 12, further including one or more monitoring stations, and wherein directing the call session data to one or more destinations includes directing the call session data to the one or more monitoring stations.

20. A method of monitoring a call session over an IP telephony network, the method comprising:
receiving a request to initiate a call session between two or more parties;
assigning the call request to a user telephone station including a telephone;
prompting a communications manager to direct call session data streams from the call session to a monitoring server, the monitoring server configured to direct the call session data streams to at least one record service or record server; and
wherein, upon receiving the call session data streams, the at least one record service or record server forwards the call session data streams to one or more monitoring stations for monitoring the call session.
